(19) United States
(12) Patent Application Publication
(10) Pub. No.: US 2024/0087297 A1
(43) Pub. Date: Mar. 14, 2024

(54) SYSTEM AND METHOD SYNTHETIC DATA GENERATION

(71) Applicant: Booz Allen Hamilton Inc., McLean, VA (US)

(72) Inventors: Luke SHELLHORN, El Segundo, CA (US); Melodie BUTZ, El Segundo, CA (US); Christopher NITHIANANDAM, Annapolis Junction, MD (US); Andrew MARTIN, Herndon, VA (US); Zachary HUMAYUN, Herndon, VA (US); Ryan CHAN, El Segundo, CA (US)

(73) Assignee: Booz Allen Hamilton Inc., McLean, VA (US)

(21) Appl. No.: 18/462,941

(22) Filed: Sep. 7, 2023

Related U.S. Application Data
(60) Provisional application No. 63/404,748, filed on Sep. 8, 2022.

(51) Int. Cl. G06V 10/774; G06V 20/40

(52) U.S. Cl. CPC G06V 10/774; G06V 20/49

(57) ABSTRACT

Exemplary systems and methods are directed to generating customized imagery includes receiving input parameters that define operations for one of plural disparate image processing tools in generating the customized imagery and define attributes of the customized imagery to be generated. Program code for generating an API is executed and the API establishes communication with each image processing tool. The API generates parameterized calls which provide instructions for a specified one of the image processing tools to generate the customized imagery. The image processing tool which receives the instructions is identified from the input parameters. The parameterized calls are sent to the parameterized calls to the image processing tool and the customized imagery is generated. The customized imagery is returned to the API and is stored in a database as training data for an artificial intelligence model.

### FIELD

The present disclosure relates to systems and methods for generating customized imagery, and more particularly synthetic imagery.

### BACKGROUND

Imagery needed for training computer vision algorithms is difficult to find. Publicly available datasets typically do not meet the targeted use cases that are required for object detection and classification algorithms. Further, unclassified data that is needed to target highly specific use cases for industry or government deployment is nearly impossible to obtain. In order to competently train models that satisfy certain use cases, fully synthetic labeled imagery, data optimization, and data augmentation is needed in to generate suitable training data. There are several prior art solutions that address this issue.

U.S. Pat. No. 11,042,758 to Jaipuria et al. discloses a system for generating a synthetic image and corresponding ground truth for training a deep neural network to predict a further location for a moving object for implementation in a vehicle. A plurality of domain adapted synthetic images are generated by processing the synthetic image with a variational auto encoder-generative adversarial network (VAE-GAN) that adapts the synthetic image from a first domain to a second domain. A deep neural network (DNN) is trained based on the domain adapted synthetic images and the corresponding ground truth. Images are processed with the trained deep neural network to determine objects. The VAE-GAN can generate large numbers (>1,000) of training images by adding domain data to synthetic images. Adding domain data to a synthetic image can include modifying the synthetic image to simulate the effects of different environmental conditions or noise factors such as precipitation including rain or snow, atmospheric/lighting conditions including fog or night, and seasonal conditions including winter and spring.

U.S. Patent Application Publication No. 2022/0076066 by Forgeat et al. discloses a method that generates synthetic data for replicating real world computing data while protecting the personal information of users and confidential information of the associated real world computing environment. The described method uses two generative adversarial networks (GANs) to generate synthetic operator data from the actual (i.e., real) collected network operator data. The first GAN is trained to produce synthetic data and the second GAN is trained to discriminate between the synthetic data and real data. The synthetic operator data is anonymized by the second GAN to provide privacy. The process can iterate until a threshold T1 is met, where the two GANs are updated on each iteration and the data generated by the second GAN is compared to the threshold T1. The synthetic data can be compared to real collected data to determine performance in terms of positive predictive value (i.e., precision) and sensitivity (i.e., recall). If the synthetic data meets the threshold T1, the machine learning models are trained using the synthesized data without violating data privacy and other confidentiality agreements.

U.S. Pat. No. 11,398,028 to Li et al. discloses a method that automatically generates synthetic images for use as training data for machine learning models to detect and/or classify various types of plant diseases shown at various stages in digital images. The machine learning model can be trained to generate synthetic plant models with plant diseases. Inputs to these models may include, for instance, the type of plant being simulated, the environmental features mentioned previously (including time series data where applicable), treatments applied to the plants, attributes of the plant disease (e.g., desired stage of progression), crops grown during previous rotations of the same agricultural area, and so forth. The machine learning model may be trained at least in part on a sequence of images that depict progression of the progressive plant disease. The images can include ground truth images captured from a controlled garden or plot in which targeted plants are deliberately afflicted with the plant disease-to-be-detected. Various types of machine learning models may be trained, e.g., using the synthetic training data to detect, classify, and/or segment plants afflicted with various diseases in imagery data. For example, a convolutional neural network (“CNN”) may be trained to generate output indicative of one or more types of plant diseases and/or diseased plants detected in digital imagery.

U.S. Patent Application No. 2022/0067451 by Wang et al. discloses a method or automatically generating quasi-realistic synthetic training images that are usable as training data for training machine learning models to perceive various types of plant traits in digital images. various aspects of the labeled simulated images (which are then used to generate the quasi-realistic synthetic training images) may be generated based at least in part on “ground truth” imagery of plants having plant traits-to-be-simulated. The ground truth imagery depicts plant(s) having some targeted trait (i.e. a trait for which there is demand to detect in digital imagery). The imagery is analyzed using various segmentation techniques to identify various plant parts, or plant “assets.” Plant assets can include various physical attributes and/or components of the depicted plant(s), such as leaf sizes, leaf shapes, leaf spatial and numeric distributions, branch sizes/shapes, flower size/shapes, etc. The plant assets can be stored as a collection of plant assets from which labeled simulated images of plant(s) can then be generated. The quasi-realistic synthetic training images can be annotated as part of the generation process, at a per-pixel level or using bounding shapes. The quasi-realistic synthetic training images may then be used for various purposes, such as training other machine learning models (e.g., CNNs) to detect various traits of plants (e.g., plant type, plant gender, plant disease, plant strain, plant health, plant malady, etc.).

Chinese Published Patent Application No. 114419541 by Wang et al. discloses a system for generating synthetic night pictures from day pictures so as to train a model for recognizing night pictures. The method uses a one-to-many adversarial network that converts a daytime picture into night pictures in different illumination environments according to set natural light and background light intensity. The daytime picture carrying label information and the synthesized night picture are used to jointly train a vehicle detection model.

U.S. Pat. No. 10,460,235 to Truong et al. discloses a method of generating a data model using GANs, wherein a synthetic data set is generated for training the model. The method involves a model optimizer receiving a data model generation request from an interface. The model optimizer is provisioned with a data model. A dataset generator generates a synthetic dataset for training the data model using a generative network of a generative adversarial network. The generative network can be trained to generate output data differing at least a predetermined amount from a reference dataset according to a similarity metric. Computing resources can use the synthetic dataset to train the data model. The model optimizer can evaluate performance criteria of the data model and store the data model and associated metadata in model storage based on the evaluation of the performance criteria of the data model. Production data can be processed using the trained data model.

U.S. Pat. No. 11,403,737 to Planche et al. discloses a method for removing noise from a depth image. A first GAN is trained by synthetic images generated from computer assisted design (CAD) information of at least one object to be recognized in real-world depth images. Real-world depth images are then presented in real-time to the first GAN. The first GAN subtracts the background portion of the real-world depth image and segments the foreground portion to produce a cleaned real-world depth image. Using the cleaned image, an object of interest in the real-world depth image can be identified via the first GAN trained with synthetic images and the cleaned real-world depth image. A second GAN receives the cleaned real-world depth image from the first GAN and processes the image with additional noise cancellation and recovery of features removed by the first GAN.

U.S. Pat. No. 10,210,861 to Arel et al. discloses a method for training a conversational agent pipeline using synthetic data, wherein synthetic data is generated due to a lack adequate audio data available. The conversational agent includes an acoustic model (AM), a transcoder, and a business logic system arranged in a pipeline. The acoustic model is trained to receive as an input an audio waveform that represents an utterance of a speaker and to output a sequence of phonemes (the basic building blocks of speech) that represent the utterance of the speaker. The transcoder is trained to receive sequences of phonemes and to output core inferences about intent (transcodes) based on the sequences of phonemes. A conversational simulator can be used to generate synthetic training data items for training the transcoder. The synthetic training data items may include a) a textual representation of a synthetic sentence and b) a transcoding of the synthetic sentence comprising one or more actions and one or more entities associated with the one or more actions included in the synthetic sentence. The synthetic sentence and associated transcodes may be associated with a restricted domain within which the conversational agent will function. Within the restricted domain, the conversational agent pipeline can be trained to provide a more natural conversational experience. The business logic system includes one or more rules that check transcodes received from the transcoder for inconsistencies and/or errors. The business logic resolves any identified inconsistencies and/or errors, and then performs one or more operations to satisfy the actions in the transcodes, such as adding items to an order.

U.S. Pat. No. 10,726,304 to Hotson et al. discloses a method of refining synthetic data with a GAN using auxiliary inputs. The discriminator network of the GAN is trained to differentiate between real data instances (e.g., real images) and synthetic data instances (e.g., virtual images) and classify data instances as either real or synthetic. The generator network of the GAN is trained to produce synthetic data instances the discriminator network classifies as real data instances. A refiner network observes a synthetic (or virtual) image and generates a variation of the synthetic image. The refiner network attempts to refine synthetic images so that the discriminator network classifies refined synthetic images as real images and also attempts to maintain similarities (e.g., regularize characteristics) between an input synthetic image and a refined synthetic image. The refiner network can be extended to receive additional information, such as one or more of: semantic maps (e.g., facilitating image segmentation), depth maps, edges between objects, etc., which can be generated as part of a synthesis process. The GAN can leverage auxiliary data streams such as semantic maps and depth maps to help ensure correct textures are correctly applied to different regions of a synthetic image.

U. S. Patent Application Publication No. 2022/0188973 by Puttagunta discloses methods for augmenting camera devices with neural networks to enhance camera performance synthetically. Synthetic camera frames are created using neural networks to interpolate between actual frame captures. Frame interpolation is used to align camera images when the frames are misaligned in time. Recorded sensor data is retroactively processed to achieve time synchronization from multiple camera sensors. Temporally misaligned camera recordings are stitched together to create spherical or panoramic images with vision pipelines augmented by neural networks. Images are enhanced by utilizing neural networks to adjust optimize resolution.

An article by Alshinina, R. A. & Elleithy, K. M, entitled “A Highly Accurate Deep Learning Based Approach for Developing Wireless Sensor Network Middleware”, IEEE Access 6 (2018): 29885-29898, discloses a secure wireless sensor network middleware based on a GAN algorithm. The generator network of the GAN creates fake data that is similar to a real sample and combines it with real data from the sensors to confuse an attacker. The discriminator network of the GAN contains multiple layers that have the ability to differentiate between real and fake data. The output of the GAN is an actual interpretation of the data that is securely communicated through the wireless sensor network.

U.S. Pat. No. 11,030,526 to Goodsitt et al. discloses a system for generating synthetic inter-correlated data. The system trains child models to generate individual datasets and trains parent models to provide latent space data that, when passed to child models as input, result in intercorrelated synthetic datasets output by the child models. The parent model generates first latent-space data and second latent-space data using a first child model to generate first synthetic data based on the first latent-space data and using a second child model to generate second synthetic data based on the second latent-space data. The first synthetic data and second synthetic data are compared to training data. The comparison can result in a parameter of the parent model being adjusted or the training of the parent model being terminated.

### SUMMARY

An exemplary method for generating customized imagery is disclosed, the method comprising: storing, in memory of a computing device, program code for generating an application programming interface (API) that communicates with plural disparate image processing tools; executing, by a computing device, the program code for generating the API; the API causing the computing device to perform operations that include: establishing communication with each image processing tool; receiving input parameters that define operations to be performed by one of the plural disparate image processing tools in generating a customized image, and define attributes of the customized imagery to be generated; generating parameterized calls based on the input parameters, the parameterized calls providing instructions for the one image processing tool configured to generate the customized image; sending parameterized calls to the one image processing tool; generating the customized imagery based on the input parameters receiving the customized imagery from the one image processing tool; and storing the received customized imagery in a database as training data for an artificial intelligence model.

An exemplary system for generating customized imagery is disclosed, the system comprising: memory storing program code for generating an application programming interface (API) that communicates with plural disparate image processing tools; receive, via an input device, input parameters that define operations for one of the image processing tools in generating the customized imagery, and define attributes of the customized imagery to be generated; execute, via a processor, the program code for generating the API; establish, by the processor, communication with each image processing tool via the API; generate, by the processor, parameterized calls based on the input parameters, the parameterized calls provide instructions for the one image processing tool configured to generate the customized imagery; send, by the processor, the parameterized calls to the one image processing tool; generate, by the processor via the one image processing tool, the customized imagery based on the input parameters; receive, by the processor via the API, the customized imagery from the one image processing tool; and store, in a database, the received customized imagery in a database as training data an artificial intelligence model.

### BRIEF DESCRIPTION OF THE DRAWINGS

Exemplary embodiments are best understood from the following detailed description when read in conjunction with the accompanying drawings. Included in the drawings are the following figures:

FIG. 1 illustrates a data pipeline for generating customized imagery according to an exemplary embodiment of the present disclosure.

FIG. 2 illustrates a method for generating customized imagery through image transformation according to an exemplary embodiment of the present disclosure.

FIG. 3 illustrates a method for generating customized imagery through synthetic image generation according to an exemplary embodiment of the present disclosure.

FIG. 4 illustrates a method for generating customized imagery by performing image transformation on a synthetically generated image according to an exemplary embodiment of the present disclosure.

FIG. 5 illustrates a computing device for generating customized imagery according to an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

Exemplary embodiments of the present disclosure relate to systems and methods for synthetic data generation engine that is compatible with multiple image transformation services (e.g., GAN imagery transformations, fully synthetic imagery creation, and imagery transformations) such that a data pipeline is established for enhanced training of computer vision (CV) algorithms. The system can store programming code for executing an application programming interface (API) that is common across multiple synthetic data services or image processing tools. The multiple synthetic data services can be aggregated with middleware of the common application programming interface (API) middleware so that targeted parameterized calls in the form of function calls, message services, or API calls can be sent to each data service. The API middleware sits on each service and provides a common translation of imagery requests. The parameterized calls generate parameterized inputs to customize synthetic generation service outputs so as to facilitate generation of customized synthetic imagery. For example, a user can interact with the API to generate parameterized calls that request a certain camera angle, a certain altitude, certain weather parameters, object types (e.g., a tank, a person, a plane etc.), allowing a user to obtain customized imagery to fit a specific object detection or classification need. The common API provides standardization which allows the use of one input format to interact with multiple imagery services. The system returns customized (e.g., synthetic) imagery to a common data repository for use in training machine learning (ML) or artificial intelligence (AI) models. The customized imagery can be sent to one or more additional transformation services (e.g., image processing tools) within the pipeline for further transformations (e.g., transform the imagery from day to night).

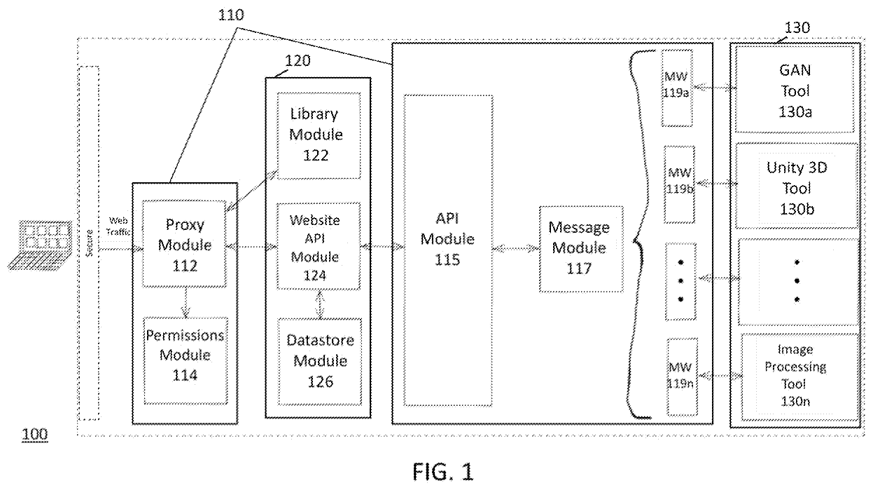

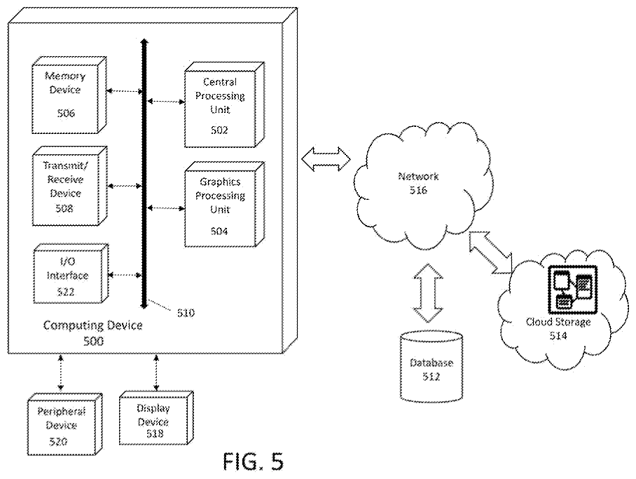

FIG. 1 illustrates a data pipeline 100 for generating customized imagery according to an exemplary embodiment of the present disclosure. The data pipeline 100 can be generated through a combination of hardware and software components of a computing device. For example, hardware components, which are discussed in FIG. 5, can include one or more processors and memory devices and the software components can include executable program code stored in the memory devices. The program code can include one or more containers with instructions for generating various components or functional modules of the data pipeline 100 for generating customized imagery according to the exemplary embodiments discussed herein. The program code can include any sets of rules that convert strings, or graphical program elements to various kinds of machine code output.

As shown in FIG. 1, the program code can include a container 110 having one or more modules for generating an application programming interface (API) that communicates with plural disparate image processing tools (e.g., synthetic data services) 130. The program code can also include a container 120 having one or more modules for generating a front-end web application for interacting with the API of container 110 and a user. According to an exemplary embodiment, the image processing tools 130 can include any number of known open source or proprietary computer-implemented applications or engines which provide for modifying or transforming an existing image to include synthetic content or the generation of a fully synthetic image. Known image processing tools can include, for example, one or more GAN-based platforms, a Unity-based platform, a Datagen-based platform, or any other suitable synthetic data generator tool or platform, or gaming engine as desired.

The container 110 can include a module 112 for routing traffic received from the network 102. According to an exemplary embodiment, the module 112 can include open source code configured as a reverse proxy which can be configured to receive user requests from the network 106 and route those requests to an appropriate client server. The container 110 can also include a module 114 that is connected to the data routing module for managing access permissions and defining policies associated with the plural data image transformation services used for generating the customized imagery. For example, the authentication module can include open source code for generating a Keycloak service that can make authorization decisions using role-based access control. The container 110 can also include an API module 115 that interacts directly with the front end-web application 120 for creating, storing, and optimizing data for CV algorithms. For example, the module 115 can receive input parameters that define an operation to be performed by one of the plural disparate image processing tools. According to exemplary embodiments of the present disclosure, the operation can involve transforming an original image to include a new style image. The input parameters are received from a user through the front-end web application 120. The input parameters can specify the original video and the type of transformation operation to be performed on the original video. For example, the input parameters can indicate that the imagery should be transformed from a day scene to night scene, from a summer scene to a winter, from a cloudy scene to a clear scene, or any other transformation as desired. According to another exemplary embodiment, the operation can involve a customized image being fully generated from synthetic data. Under this embodiment, the input parameters include an image identifier, an image number, a scene identifier, a scene type (string), and an object identifier. In addition, the input parameters can also include image attributes defining camera angle, altitude, weather parameters, lighting parameters, an object type, and a number of images to capture.

The container 110 includes a module 117 that performs messaging operations for communicating with each of the image processing tools 130a-130n. The module 117 can include plural middleware modules 119a-119n where each middleware module is configured for communicating with a specified one of the image processing tools 130a-130n, respectively. For example, each API middleware module 119a-119n can generate parameterized calls based on the input parameters received from the front-end web application. The parameterized calls provide instructions for the one image processing tool 130a-130n configured to generate the customized image. According to an exemplary embodiment when a customized image is generated through an image transformation, the parameterized calls can include generating an instruction message having a message identifier and a message body. The identifier can include a name of the original image and a timestamp. The message body can include the name of original image, an identifier of the original image, and the one or more attributes of the original image to be transformed. According to another exemplary embodiment when a customized image involves fully synthetic image generation, the module 115 can generate a request message that includes at least the input parameters. The module 117 receives the request message and verifies that the one or more input parameters in the request message include at least the image identifier, the image number, the scene identifier, and the scene type (string). When the one or more input parameters are verified, the module 117 generates the parameterized call as an instruction message for placement in the job queue of the image processing tool specified for generating the synthetic image. The instruction message can include a message identifier and a message body. The identifier can contain plural values comprised of at least the scene identifier, the image identifier, and a timestamp. The message body can also contain plural values, which comprise at least the scene identifier and the scene type.

The module 117 via a specified one of the API middleware modules 119a-119n sends the parameterized calls to an associated one of the plural image processing tools 130a-130n, respectively. The specified image processing tool 130a-130n initiates a sequence of operations based on receipt of the parameterized call including loading the instruction message into a job queue and extracting at least the name of the original image and the one or more attributes of the input parameters which define the image processing operation(s) to be performed. For example, with regard to image processing tools of GAN-based platforms, the one or more attributes can specify an image transformation (e.g., style transfer) to be performed. Once the messages from API middleware module 119a are loaded into the job queue, the image processing tool 130a downloads the original image from memory (cloud, database, etc.) and performs the image processing steps as specified by one or more attributes to generate the customized image. With regard to an operation involving synthetic image generation, the API middleware module 119b loads messages into the job queue of image processing tool 130b. The image processing tool 130b extracts the scene identifier and the scene type from the instruction message. The image processing tool 130b then uses the one or more attributes, which can specify a camera angle, altitude, object type, or a number of images to capture for the style-transfer GAN operation to generate the customized imagery. The exemplary operations disclosed herein can be performed on photographic or video images. For an image transformation operation performed by the image processing tool 130a on video images, the image processing steps can include dividing the video into plural frames, transforming each frame according to the one or more attributes, and compiling the plural transformed frames back into the video format. For an exemplary operation in which a Unity-based platform is used to generate a fully synthetic image, the image processing tool 130b records a video scene based on camera movements determined by the input parameters, calculates locations of objects in the recorded video scene, and creates a detection label for the calculated locations of each object. A detection label can include define a class (e.g., type of object such as “tank” or “person”) and a bounding box which includes the coordinates that describe a rectangle that exactly surrounds the object.

Once the customized image is generated, the image processing tool 130b of a Unity-based platform, can upload the generated synthetic image and detection label to memory (cloud, database), send notification to the module 115 that the synthetic image has been generated; and delete the instruction message from the job queue. The module 115 can receive the image from the image processing tool 130b via the API middleware module 119b. If the one or more attributes of the input parameters specify a number of images to capture for the style-transfer GAN operation, as well as, the one or more style images to apply to the original customized image, the module 115 can pass the received customized image to the image processing tool 130a of a GAN-based platform to generate one or more additional images through image transformation operations. For this operation, the module 117 uses the API middleware module 119a to generate a parameterized call as an instruction message having a message identifier and a message body. The identifier can contain plural values including at least a name of the generated synthetic image (e.g., original customized image) and a timestamp associated with generation of the customized image. The message body can also contain plural values including the name of generated synthetic image, the identifier of the generated synthetic image, and the one or more attributes of the generated synthetic image to be transformed.

The image processing tool 130a can receive the parameterized call from the API middleware module 119a based on the original customized image and load the instruction message of the parameterized call into the job queue. Based on the instruction message, the image processing tool 130a can initiate a series of image transformation steps which include extracting at least the name of the generated synthetic image (e.g., original customized image) and the one or more attributes to be transformed from the instruction message, downloading the generated synthetic image from memory (cloud, database, etc.), and customizing the generated synthetic image according to the one or more attributes. Once the image transformation is complete, the customized imagery is uploaded to memory and the instruction message is deleted from the job queue.

Once all image processing operations have been performed by the image processing tools as defined in the input parameters, the module 115 receives the customized image(s) from the image processing tool 130a via the API middleware module 119a and stores them in a database for training an artificial intelligence (AI) model. For example, the newly generated customized imagery can be added to an existing training dataset or used to create a new training dataset for an AI model.

The container 120 can include one or more modules for generating the visual elements of a website. According to an exemplary embodiment, the container 120 can include a module 122 configured with known code for generating a JavaScript library (e.g., React), a module 124 configured with open source code for generating a known framework and/or toolkit for building an API for the website (e.g., Python Django), a module 126 configured with open source code for generating a known datastore and/or data warehouse for use with the API of module 124. It should be understood that the container 120 could include any open source or proprietary web application model suitable for use with the modules of container 110.

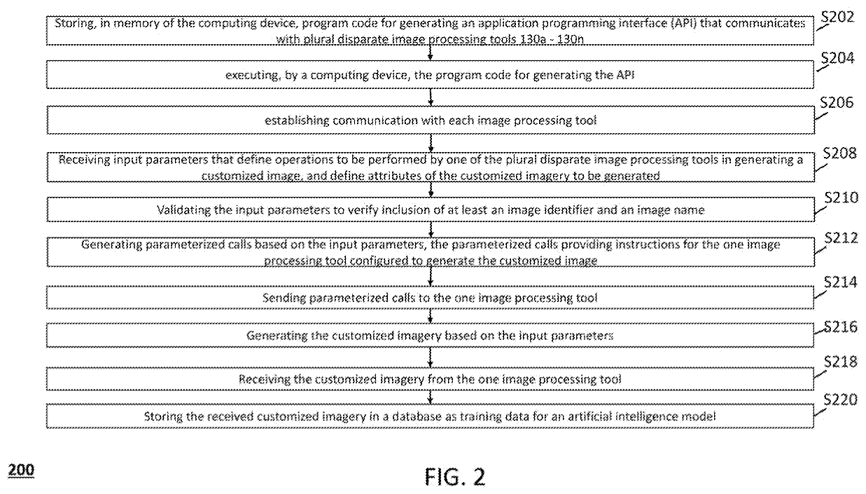

FIG. 2 illustrates a method 200 for generating customized imagery by performing an image transformation according to an exemplary embodiment of the present disclosure.

The method 200 can be performed by one or more computing devices, which will be described in further detail in FIG. 5. The computing devices can include a combination of hardware and software components configured to implement the data pipeline of FIG. 1. As shown in FIG. 2, the method 200 includes storing, in memory of the computing device, program code for generating an application programming interface (API) that communicates with plural disparate image processing tools 130a-130n (S202). The computing device executes the program code for generating the API (S204). Once the API is generated, the computing device establishes communication with each image processing tool via a corresponding API middleware module 119a-119n (S206). The image processing tools can be executed physically or virtually on the computing device. Once communication between the API and the image processing tools 130a-130n is established, the computing device receives input parameters that define an image transformation operation to be performed by one of the image processing tools in generating the customized imagery (S208). For example, the input parameters specify the original video to be transformed and the type of transformation (e.g., style image). The input parameters also define attributes of the customized imagery to be generated, as well as attributes of the original image that are to be modified to generate the customized image. The input parameters are validated to verify inclusion of at least an image (e.g., video) identifier and an image (e.g., video) name (S210). The computing device generates parameterized calls using the API middleware module 119a-119n based on the input parameters, where the parameterized calls provide instructions for the one image processing tool 130a-130n configured to generate the customized image (S212). For example, the parameterized calls can include an instruction message having an identifier that includes a name of the original image and a timestamp, and a body that includes the name of original image, and identifier of the original image, and the one or more attributes of the original image to be transformed. Table I provides an example of pseudocode for performing steps S202 to S212.

TABLE I

```
  synthetic_endpoint(req):
    get req body as JSON or return error
    get parameters from req body or return error
    validate that parameters include:
      at least one video dict in format:
        {id: some_number, name: name_of_vid}
      a transformation that is one of the supported
        transformations (‘snow’, ‘day’, ‘night’)
    for each video:
      create message in job queue for synthetic generation
      message id includes video name and timestamp
message body includes video name, id, and transformation
```

The parameterized calls are sent by the API middleware module 119a to the one image processing tool 130a (S214). In performing the operations of the image processing tool 130a, the computing device loads the instruction message into a job queue of the one image processing tool 130a and extracts at least the name of the original image and the one or more attributes to be transformed. The original image is downloaded from memory (e.g., cloud, database, etc.) and a style transfer (e.g., change in scenery based on weather, season, time of day, etc., as desired) or image transformation is performed on the original image using the one or more attributes (S216). In generating the customized imagery, the computing device, divides the video image into plural frames, transforms each frame according to the one or more attributes, and compiles the plural transformed frames into the video format. The customized imagery is uploaded to memory, the instruction message is deleted from the job queue, and the image is provided to the API module 115. The customized imagery is received image from the image processing tool 130a via the API middleware module 119a (S220). The computing device stores the received customized imagery in a database for training an artificial intelligence model (S218). Table II provides an example of pseudocode for performing steps S214 to S222.

TABLE II

```
  (GAN model) main:
    long poll job queue for job
    when there is a job:
      get video name and transformation from job
      download video from s3
      run GAN model on video to apply transformation
        (break video into frames to apply per frame,
        then compile back into video)
      upload resulting video to s3
delete job from queue
```

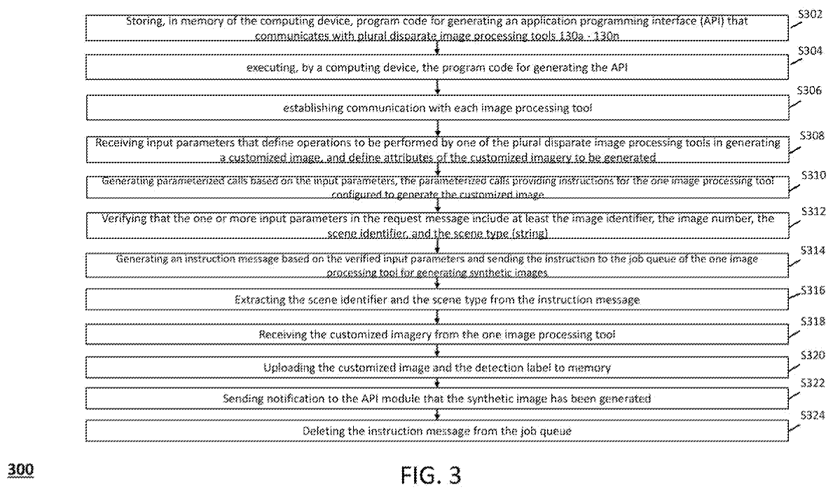

FIG. 3 illustrates a method 300 for generating customized imagery by performing a synthetic image generation according to an exemplary embodiment of the present disclosure.

As shown in FIG. 3, the method 300 includes storing, in memory of the computing device, program code for generating an application programming interface (API) that communicates with plural disparate image processing tools 130a-130n (S302). The computing device executes the program code for generating the API (S304). Once the API is generated, the computing device establishes communication with each image processing tool (S306). Once communication between the API and the image processing tools 130a-130n is established, the computing device receives input parameters that define the synthetic image generation operation to be performed by one of the image processing tools in generating the customized imagery (S308). The input parameters include at least an image identifier, an image number, a scene identifier, a scene type (string), and an object identifier. The input parameters also include one or more attributes of the customized image to be generated. The attributes include at least one of a camera angle, an altitude, weather parameters, lighting parameters, an object type, and a number of images to capture in performing image transformation operations on the synthetic image that is generated. The computing device generates parameterized calls via the API middleware module 119b based on the input parameters, where the parameterized calls provide instructions for the image processing tool 130b configured to generate the customized imagery (S310). In generating the parameterized calls, the computing device generates a request message that includes at least the input parameters. The computing device verifies that the one or more input parameters in the request message include at least the image identifier, the image number, the scene identifier, and the scene type (string) (S312). If the one or more input parameters are verified, an instruction message is generated through module 117 and sent to the job queue of the image processing tool 130b that generates synthetic images (S314). According to exemplary embodiments, the instruction message includes at least a message identifier that contains the scene identifier, the image identifier, and a timestamp, and a message body that contains the scene identifier and the scene type. Table III provides an example of pseudocode for performing steps S302 to S314.

TABLE III

```
  unity_synthetic_endpoint(req):
    get req body as JSON or return error
    get parameters from req body or return error
    validate that parameters include:
      id, a number, and scene, a string that is one of
        the supported scene types
    create message in job queue for synthetic generation
    message id includes scene, id, and timestamp
message body includes scene type and id
```

In performing the operations of the image processing tool 130a-130n, the computing device extracts the scene identifier and the scene type from the instruction message (S316) and generates the synthetic image in the one image processing tool based on at least the scene identifier and the scene type (S318). The computing device generates the synthetic image via the image processing tool 130b by recording the scene based on camera movements determined by the input parameters, calculating locations of objects in the recorded scene, and creating detection labels from the calculated locations of the objects. Once the synthetic image generation operation is completed, the customized image and the detection label are uploaded to memory (cloud, database) (S320). The image processing tool 130b sends notification to the API module 115 via the API middleware module 119b that the synthetic image has been generated (322), and the instruction message is deleted from the job queue (324). Table IV provides an example of pseudocode for performing steps S316 to S324.

TABLE IV

```
  (Unity) main:
    long poll job queue for job
    when there is a job:
      get scene and id from job
      run desired Unity scene
        (build scene, record from predetermined
        camera movements, and create detection labels
        from calculated locations of objects in
        scene)
      upload resulting video and detection label csv
        to s3
      send notification that job completed
delete job from queue
```

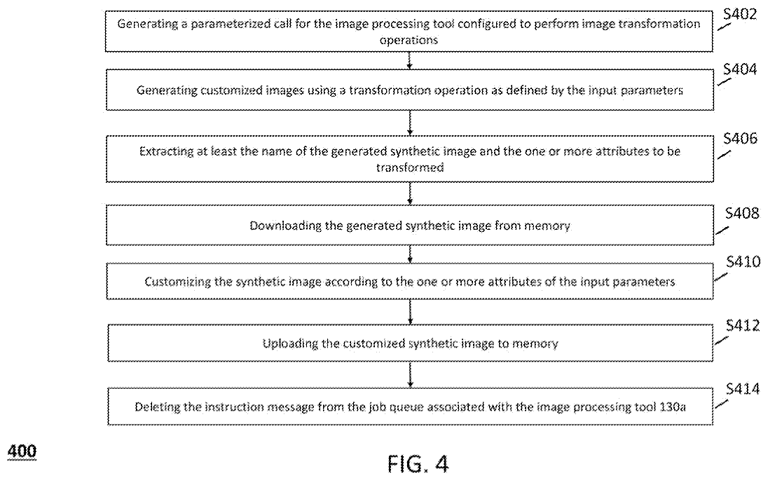

FIG. 4 illustrates a method 400 for generating customized imagery by performing an image transformation on a synthetically generated image according to an exemplary embodiment of the present disclosure.

The method 400 is performed by the computing device when the input parameters received by the API module 115 indicate that the customized image is to be generated through synthetic image generation operations and the input parameters also define a number of images to capture in performing image transformation operations on the synthetic image that is generated. If these two conditions are met, as shown in FIG. 4, the computing device generates a parameterized call via the API middleware module 119a for the image processing tool 130a, which is configured to perform image transformation operations (S402). The parameterized call includes an instruction message having a message identifier that contains at least a name of the generated synthetic image and a timestamp indicating a creation date and/or time of the synthetic image. The instruction message also includes a message body that contains at least the name of generated synthetic image, and the identifier of the generated synthetic image, and the one or more attributes of the generated synthetic image to be transformed. The instruction message is loaded into a job queue associated with the image processing tool 130a that generates customized images using a transformation operation as defined by the input parameters (S404). The computing device, via the image processing tool 130a, extracts at least the name of the generated synthetic image and the one or more attributes to be transformed (S406) and downloads the generated synthetic image from memory (cloud, database, etc.) (S408). The computing device customizes the synthetic image according to the one or more attributes of the input parameters (S410), and once completed, uploads the customized synthetic image to memory (S412). The method 400 ends with the computing device deleting the instruction message from the job queue associated with the image processing tool 130a (S414).

As shown in FIG. 5 a computing device 500 configured for performing the exemplary embodiments described herein can be configured to include a central processing unit (CPU) 502, a graphics processing unit (GPU) 504, a memory device 506, and a transmit/receive device 508. The CPU 502 can include a special purpose or a general purpose hardware processing device encoded with program code or software for scheduling and executing processing tasks associated with the overall operation of the computing device 500. For example, the CPU 502 can establish the platform necessary for executing the plural image processing tools 130a-130n. The CPU 502 can be connected to a communications infrastructure 510 including a bus, message queue, network, multi-core message-passing scheme, etc., for communicating data and/or control signals with other hardware components of the computing device 300. According to an exemplary embodiment, the CPU 502 can include one or more processing devices such as a microprocessor, central processing unit, microcomputer, programmable logic unit or any other suitable hardware processing device as desired. The GPU 504 can include a combination of hardware and software components, such as a special purpose hardware processing device being configured to execute or access program code or software for rendering images in a frame buffer for display. For example, the GPU 504 can include an arithmetic logic unit, at least 128 KB of on-chip memory, and be configured with an application program interface such as Vulkan, OpenGL ES (Open Graphics Library for Embedded Systems), OpenVG (OpenVector Graphics), OpenCL (Open Computing Language), OpenGL (Open Graphics Library), Direct3D, or any other suitable hardware and/or software platform as desired for executing a customized image generation application or process as described herein.

According to an exemplary embodiment of the present disclosure, the GPU 504 can be configured to execute any of image processing tools 130a-130n for performing image transformation operations and/or synthetic image generation operations as described herein.

The computing device 500 can also include a memory device 506. The memory device 506 can be configured to store the customized images generated by the GPU 504. The memory device 506 can include one or more memory devices such as volatile or non-volatile memory. For example, the volatile memory can include random access memory, read-only memory, etc. The non-volatile memory of the memory device 506 can include one or more resident hardware components such as a hard disk drive and a removable storage drive (e.g., a floppy disk drive, a magnetic tape drive, an optical disk drive, a flash memory, or any other suitable device). The non-volatile memory can include an external memory device such as a database 512 and/or cloud storage 514 connected to the computing device 500 via the network 516. According to an exemplary embodiment, the non-volatile memory can include any combination of resident hardware components or external memory devices. Data stored in computing device 500 (e.g., in a non-volatile memory) may be stored on any type of suitable computer readable media, such as optical storage (e.g., a compact disc, digital versatile disc, Blu-ray disc, etc.) or magnetic tape storage (e.g., a hard disk drive). The stored data can include image data generated by the GPU 504, control and/or system data stored by the CPU 502, and software or program code used by the CPU 502 and/or GPU 504 for performing the tasks associated with the exemplary embodiments described herein. The data may be configured in any type of suitable database configuration, such as a relational database, a structured query language (SQL) database, a distributed database, an object database, etc. Suitable configurations and storage types will be apparent to persons having skill in the relevant art.

The transmit/receive device 508 can include a combination of hardware and software components for communicating with other computing devices connected to the network 516. The transmit/receive device 508 can be configured to transmit/receive data signals and/or data packets over the network 516 according to a specified communication protocol and data format. During a receive operation, the transmit/receive device 508 can identify parts of the received data via the header and parse the data signal and/or data packet into small frames (e.g., bytes, words) or segments for further processing by the CPU 502 or GPU 504. During a transmit operation, the transmit/receive device 508 can assemble data received from the CPU 502 or GPU 504 into a data signal and/or data packets according to the specified communication protocol and/or data format of the network 516 or receiving device. The transmit/receive device 508 can include one or more receiving devices and transmitting devices for providing data communication according to any of a number of communication protocols and data formats as desired. For example, the transmit/receive device 508 can be configured to communicate over the network 516, which may include a local area network (LAN), a wide area network (WAN), a wireless network (e.g., Wi-Fi), a mobile communication network, a satellite network, the Internet, optic fiber, coaxial cable, infrared, radio frequency (RF), or any combination thereof. Other suitable network types and configurations will be apparent to persons having skill in the relevant art. According to an exemplary embodiment, the transmit/receive device 116 can include any suitable hardware components such as an antenna, a network interface (e.g., an Ethernet card), a communications port, a PCMCIA slot and card, or any other suitable communication components or devices as desired.

The computing device 500 can include a display device 518 configured to display one or more interfaces and/or images generated by the CPU 502 and GPU 504. The GPU 504 can be configured to generate a data signal encoded with the video data and send the data signal to the display device 518 via the communications infrastructure 510. The display device 518 can include any one of various types of displays including light emitting diode (LED), micro-LED, organic LED (OLED), active-matrix organic LED (AMOLED), Super AMOLED, thin film transistor (TFT), TFT liquid crystal display (TFT LCD), in-plane switching (IPS), or any other suitable display type as desired. According to an exemplary embodiment, the display device 518 can be configured to have a resolution at any of 5K, 4K, 2K, high definition (HD), full HD, and a refresh rate including any one of 60 Hz, 90 Hz, 120 Hz or any other suitable resolution and refresh rate as desired.

The peripheral device 520 is configured to output the data signal in a format selected by a user. For example, the peripheral device 520 can be implemented as another display device, printer, speaker, or any suitable output device with a desired output format as desired. In addition, the I/O peripheral device 520 can be configured to provide a data signal to the CPU 502 or GPU 504 via the I/O interface 522. According to an exemplary embodiment, the peripheral device 520 can be connected to receive data from the network 516 via computing device 500, and more particularly via the input/output (I/O) interface 522. The I/O interface 522 can include a combination of hardware and software components. The I/O interface 522 can be configured to convert the output of the network 516 into a format suitable for output on one or more types of peripheral devices 520.

The computer program code for performing the specialized functions described herein can be stored on a computer usable medium, which may refer to memories, such as the memory devices for the computing device 500, which can be memory semiconductors (e.g., DRAMs, etc.). These computer program products can be a tangible non-transitory means for providing software to the various hardware components of the respective devices as needed for performing the tasks associated with the exemplary embodiments described herein. The computer programs (e.g., computer control logic) or software can be stored in the memory device. According to an exemplary embodiment, the computer programs can also be received and/or remotely accessed via the receiving device 508 of the computing device 500 as needed. Such computer programs, when executed, can enable the computing device 500 to implement the present methods and exemplary embodiments discussed herein, and may represent controllers of the computing device 500. Where the present disclosure is implemented using software, the software can be stored in a non-transitory computer readable medium and loaded into the computing device 500 using a removable storage drive, an interface, a hard disk drive, or communications interface, etc., where applicable.

The one or more processors of the computing device 500 can include one or more modules or engines configured to perform the functions of the exemplary embodiments described herein. Each of the modules or engines can be implemented using hardware and, in some instances, can also utilize software, such as program code and/or programs stored in memory. In such instances, program code may be compiled by the respective processors (e.g., by a compiling module or engine) prior to execution. For example, the program code can be source code written in a programming language that is translated into a lower level language, such as assembly language or machine code, for execution by the one or more processors and/or any additional hardware components. The process of compiling can include the use of lexical analysis, preprocessing, parsing, semantic analysis, syntax-directed translation, code generation, code optimization, and any other techniques that may be suitable for translation of program code into a lower level language suitable for controlling the computing device 500 to perform the functions disclosed herein. It will be apparent to persons having skill in the relevant art that such processes result in the computing device 500 being specially configured computing devices uniquely programmed to perform the functions discussed above.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein.

What is claimed is:

1. A method for generating customized imagery, the method comprising:
storing, in memory of a computing device, program code for generating an application programming interface (API) that communicates with plural disparate image processing tools;
executing, by a computing device, the program code for generating the API;
the API causing the computing device to perform operations that include:
establishing communication with each image processing tool;
receiving input parameters that define operations to be performed by one of the plural disparate image processing tools in generating a customized image, and define attributes of the customized imagery to be generated;
generating parameterized calls based on the input parameters, the parameterized calls providing instructions for the one image processing tool configured to generate the customized image;
sending parameterized calls to the one image processing tool;
generating the customized imagery based on the input parameters;
receiving the customized imagery from the one image processing tool; and
storing the received customized imagery in a database as training data for an artificial intelligence model.

2. The method of claim 1, wherein the operations involve an image transformation and the input parameters further identify an original video and a type of transformation to be performed.

3. The method of claim 2, wherein the input parameters further identify one or more attributes of the original video that are to be modified to generate the customized imagery.

4. The method of claim 3, wherein the attributes include one or more style transfers to be performed on the original video.

5. The method of claim 2, wherein the step of sending parameterized calls further comprises:
generating an instruction message having:
an identifier that includes a name of the original video and a timestamp; and
a body that includes the name of original video, and identifier of the original video, and the one or more attributes of the original video to be transformed.

6. The method of claim 5, wherein the computing device performs further operations including:
loading the instruction message into a job queue of the one image processing tool;
extracting at least the name of the original video and the one or more attributes to be transformed;
downloading the original image from memory;
executing the one image processing tool to customize the original video using the one or more attributes; and
uploading the customized image to memory; and
delete the instruction message from the job queue.

7. The method of claim 6, wherein customizing the original video includes:
dividing the original video into plural frames;
transforming each frame according to the one or more attributes; and
compiling the plural transformed frames into the video format.

8. The method of claim 1, wherein the operation involves synthetic image generation and the input parameters include an image identifier, an image number, a scene identifier, a scene type, and an object identifier.

9. The method of claim 8, wherein the attributes include at least one of: camera angle, altitude, weather parameters, lighting parameters, an object type, and a number of images to capture.

10. The method of claim 8, wherein the step of sending parameterized calls further comprises:
generating a request message that includes at least the input parameters.

11. The method of claim 10, further comprising:
verifying that the one or more input parameters in the request message include at least the video identifier, the video number, the scene identifier, and the scene type (string).

12. The method of claim 11, wherein when the one or more input parameters are verified, the method comprises:
generating an instruction message in the job queue of the one image processing tool that generates synthetic images.

13. The method of claim 12, wherein the instruction message includes:
an identifier that contains the scene identifier, the image identifier, and a timestamp; and
a body that contains the scene identifier and the scene type.

14. The method of claim 13, further comprising:
extracting the scene identifier and the scene type from the instruction message.

15. The method of claim 14, further comprising:
executing the one image processing tool; and
generating the synthetic video in the one image processing tool based on at least the scene identifier and the scene type.

16. The method of claim 15, wherein the generating the synthetic image comprises:
recording the scene based on camera movements determined by the input parameters;
calculating locations of objects in the recorded scene; and
creating detection labels from the calculated locations of the objects.

17. The method of claim 16, comprising:
uploading the generated synthetic video and detection label to memory (cloud, database);
sending notification that the synthetic video has been generated; and
deleting the instruction message from the job queue.

18. The method of claim 17, wherein the instruction message is a first instruction message and the step of sending parameterized calls comprises:
generating a second instruction message including:
an identifier that contains a name of the generated synthetic video and a timestamp; and
a body that contains the name of generated synthetic video, and the identifier of the generated synthetic video, and the one or more attributes of the generated synthetic video to be transformed.

19. The method of claim 18, wherein the computing device performs further operations including:
loading the second instruction message into a job queue associated with a second image processing tool that generates customized images;
extracting at least the name of the generated synthetic image and the one or more attributes to be transformed;
downloading the generated synthetic video from memory;
executing the second image processing tool and customizing the generated synthetic video according to the one or more attributes; and
uploading the customized synthetic video to memory; and
deleting the second instruction message from the job queue.

20. The method of claim 19, wherein transforming the generated synthetic video includes:
dividing the generated synthetic video into plural frames;
transforming each frame according to the one or more attributes; and
compiling the plural transformed frames into the video format.

21. A system for generating customized imagery, the system comprising:
memory storing program code for generating an application programming interface (API) that communicates with plural disparate image processing tools;
receive, via an input device, input parameters that define operations for one of the image processing tools in generating the customized imagery, and define attributes of the customized imagery to be generated;
execute, via a processor, the program code for generating the API;
establish, by the processor, communication with each image processing tool via the API;
generate, by the processor, parameterized calls based on the input parameters, the parameterized calls provide instructions for the one image processing tool configured to generate the customized imagery;
send, by the processor, the parameterized calls to the one image processing tool;
generate, by the processor via the one image processing tool, the customized imagery based on the input parameters;
receive, by the processor via the API, the customized imagery from the one image processing tool; and
store, in a database, the received customized imagery in a database as training data an artificial intelligence model.
